(19) United States
(12) Patent Application Publication
(10) Pub. No.: US 2013/0226666 A1
(43) Pub. Date: Aug. 29, 2013

(54) METHODS AND APPARATUS TO SAMPLE MARKETS BASED ON AERIAL IMAGES

(71) Applicants: Alex Terrazas, Santa Cruz, CA (US); Paul Donato, New York, NY (US)

(72) Inventors: Alex Terrazas, Santa Cruz, CA (US); Paul Donato, New York, NY (US)

(21) Appl. No.: 13/774,784

(22) Filed: Feb. 22, 2013

Related U.S. Application Data
(60) Provisional application No. 61/602,423, filed on Feb. 23, 2012.
(60) Provisional application No. 61/603,756, filed on Feb. 27, 2012.

(51) Int. Cl. G06Q 30/02

(52) U.S. Cl. CPC G06Q 30/0205
USPC 705/7.34

(57) ABSTRACT

Methods and apparatus to sample markets based on aerial images are disclosed. An example method includes identifying a first geographic area to be sampled for a first product, the identifying being based on an aerial image, estimating a density of the first product in the first geographic area, and calculating a sampling rule to be used in sampling the first geographic area for the first product.

### RELATED APPLICATION

This patent claims priority to U.S. Provisional Patent Application Ser. No. 61/602,423, which was filed on Feb. 23, 2012, and to U.S. Provisional Patent Application Ser. No. 61/603,756, which was filed on Feb. 27, 2012, the entireties of which are hereby incorporated by reference.

### FIELD OF THE DISCLOSURE

This disclosure relates generally to sampling markets and, more particularly, to methods and apparatus to sample markets based on aerial images.

### BACKGROUND

Market channels are described by supply (e.g., product delivery capacity, numbers of stores, and product availability), and by demand (e.g., an amount of product sold and which types of merchants (retail outlets, wholesalers, club stores, etc.) sell the products). Market channels vary between geographic locations and over time.

### BRIEF DESCRIPTION OF THE DRAWINGS

FIG. 1 is a block diagram of an example system constructed in accordance with the teachings of this disclosure to analyze markets based on aerial images.

FIG. 2 illustrates an example aerial image that may be used to sample products and/or stores in a market.

FIG. 3 is a chart illustrating sampling counts resulting from an example sampling procedure based on identified patches and generated sampling rules.

FIG. 4 is a flowchart representative of example computer readable instructions which may be executed to generate a sampling plan to sample products in a market based on aerial images.

FIG. 5 is a flowchart representative of an example method to perform sampling of products in a geographic area.

FIG. 6 is a flowchart representative of example computer readable instructions which may be executed to determine a total count of an object of interest from sampling data collected based on sampling rules.

FIG. 7 is a block diagram of an example processor platform capable of executing the instructions of FIGS. 4, 5, and/or 6 to implement the system 100 of FIG. 1.

The figures are not to scale. Wherever possible, the same reference numbers will be used throughout the drawing(s) and accompanying written description to refer to the same or like elements.

### DETAILED DESCRIPTION

Traditional methods for counting stores employ human surveyors. Such traditional methods suffer from many shortcomings including high costs, low temporal resolution, and/or an inability to estimate markets in many areas due to dangerous conditions and/or geopolitical reasons. Aerial imaging (e.g., satellite-based photography, aircraft-based photography, satellite-based infrared imaging, etc.) offers a number of capabilities for estimating commercial activity in developing and/or developed geographic areas.

Optimal foraging theory describes an idea that natural selection favors behaviors that gather food in the most efficient ways. At a basic level, optimal foraging theory attempts to explain behaviors (e.g., animal foraging behaviors) in ways that increase (e.g., maximize) energy intake while decreasing (e.g., minimizing) the energy required to forage for food. Optimal foraging theory includes numerous assumptions that are applied by example methods and apparatus disclosed herein to the process of sampling or surveying market channels. Example methods and apparatus disclosed herein use optimal foraging theory to generate sampling plans including one or more sampling rules which may be executed by samplers (e.g., human surveyors) to increase the information obtained while decreasing the costs associated with manual sampling or surveying. In contrast with previously known methods of sampling or surveying, example methods and apparatus disclosed herein provide more valuable information on current and/or emerging markets with reduced cost of obtaining the information.

Example methods and apparatus disclosed herein enable improved access to sampling in locations where human sampling was previously impracticable. For example, some locations may previously have required the assumption of excessive human and/or monetary risk to obtain uncertain market channel information. Some example methods and apparatus disclosed herein may decrease the uncertainty of obtaining valuable market channel information and/or decrease the monetary and/or human time investments required to obtain the market channel information, thereby lowering risk and increasing the practicability of performing sampling.

Example methods and apparatus disclosed herein analyze aerial images to generate efficient sampling plans of stores and/or products. Example methods and apparatus disclosed herein analyze aerial images to identify characteristics of a geographic area of interest. Some example methods and apparatus disclosed herein combine the identified characteristics with market channel information obtained from similar areas to predict or estimate patches of the geographic area to be sampled. Such patches may be indicative of emerging markets and/or may be representative of an area larger than the patches.

Example methods and apparatus disclosed herein generate sampling plans that may result in higher sampling counts of the product(s) and/or store(s) of interest than would be representative of a geographic area of interest as a whole. Some example methods and apparatus disclosed herein generate a sampling plan to direct or instruct a sampler to search and sample for product(s) and/or store(s) of interest in a subregion (or patch) that has been estimated to have a higher-than-average concentration of the product(s) and/or store(s) of interest. Furthermore, some example sampling plans disclosed herein instruct the sampler to stop sampling a patch when a particular rate of sampling and/or length of searching time reach a threshold (e.g., an average sampling rate). Some example methods and apparatus disclosed herein correct for the above-average sampling counts by applying optimal foraging theory to extrapolate the sampling counts to estimate a total number of product(s) and/or store(s) of interest that is representative of a geographic area of interest.

Example methods and apparatus disclosed herein may be used to efficiently and effectively estimate markets in areas such as those in the developing world, where market channel data are very sparse. Furthermore, developing or emerging markets are more dynamic (e.g., develop or change more rapidly) than more established and/or stable markets. Sampling data for more dynamic markets therefore becomes obsolete more quickly than sampling data for more stable markets. By analyzing aerial images of areas of interest, example methods and apparatus disclosed herein enable more effective concentration of sampling or surveying resources on emerging markets than known sampling methods. Example methods and apparatus disclosed herein enable bypassing of less valuable products and stores in favor of more valuable products and stores. For example, some disclosed methods and apparatus generate sampling rules to cause store(s), store type(s), product(s), and/or product type(s) that provide more or better information about the characteristics of an emerging market to be favored over store(s), store type(s), product(s), and/or product type(s) that provide less information.

As used herein, a store refers generally to any class (e.g., type and/or brand) of store (e.g., retailer, wholesaler, shopping club, etc.) of any brand. As used herein, a store brand refers to a particular merchant (e.g., Walmart®) or instance of a type of store. As used herein, a store type refers to a class of store. For example, types of stores may include a retail store class, a wholesaler store class, a club store class, a convenience store class, and an open market store class, among others. In contrast, store brands may include a specific instance (e.g., a single location) of a store associated with a particular merchant. As used herein, a product brand refers to a particular trade name or instance of a type of product (e.g., Crest toothpaste). A product type refers to a class of product. For example, product types may include soft drinks, soap, and potato chips, among others. In contrast, a product generally refers to a unit (e.g., a bag or box) of any class (e.g., type and/or brand) of product (e.g., potato chips or the presence of a particular brand of potato chips). Store types, store brands, product brands, and/or product types may be drawn at any level of distinction, such as potato chips, salty snacks, snacks, and/or food, among others, for product types. As used herein, product of interest refers to any or all of product type and/or product brand. As used herein, store of interest refers to any or all of store type and/or store brand.

As used herein, a “market channel” refers to a path of a product of interest as it moves from a producer to an ultimate consumer or user. As used herein, sampling and/or surveying a market channel refers to the process of physically counting instances of an object of interest, such as a product or a store, within a designated area. Market sampling can be used to extrapolate a counted number to a number representing the entire designated area, while surveying refers to an attempt to enumerate all instances. Sampling and surveying may be referred to herein as “determining a number.”

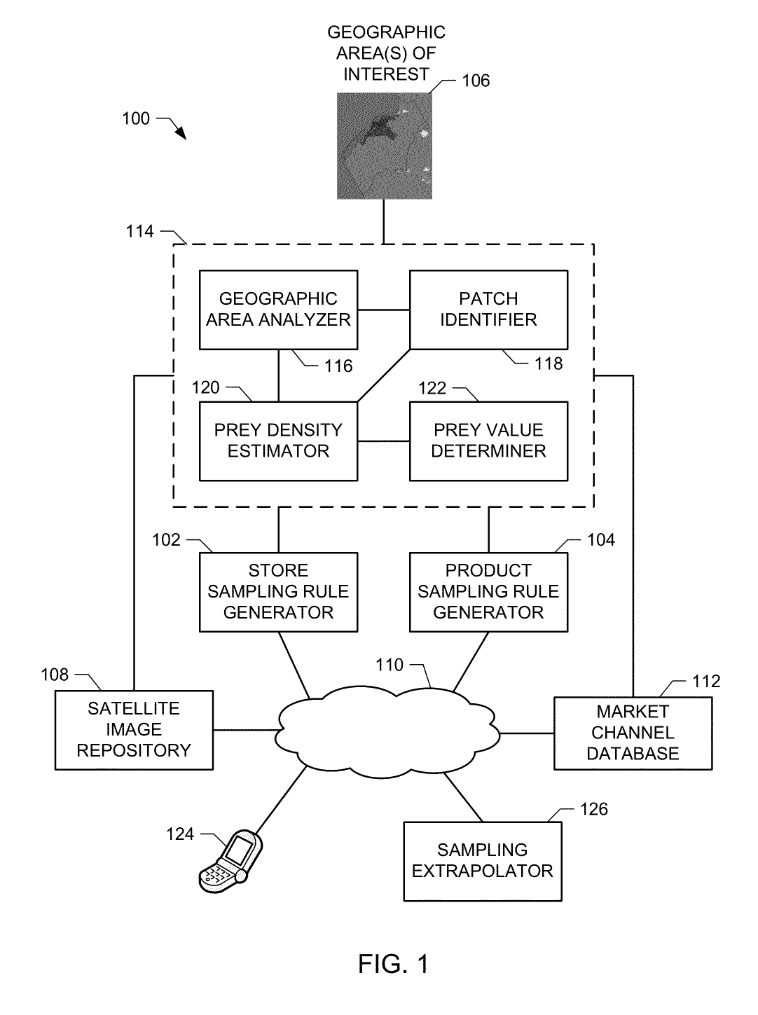

FIG. 1 is a block diagram of an example system 100 to analyze markets based on aerial images. The example system 100 of FIG. 1 may be used to generate rules for efficiently and effectively sampling market channels using optimal foraging techniques. Optimal foraging refers to the behavior of maximizing intake (e.g., food, information) while minimizing search and/or handling costs of intake (e.g., energy, time, monetary value). Optimal foraging can be applied to different forms of intake. For example, in nature, optimal foraging is reflected in the behaviors of animals that promote efficient collection of food while minimizing time and/or energy expenditures to collect the food. Additionally, behaviors such as selectively ignoring or skipping over lower calorie or fat value foods when higher calorie or fat value foods are available may promote efficient collection of food. The example system 100 of FIG. 1 generates sampling rules and/or sampling plans according to optimal foraging theory to promote cost-effective market channel sampling, such as in emerging markets. To this end, the example system 100 uses aerial images to identify patches, or areas, that likely contain higher numbers of the item(s) or object(s) to be sampled.

The example system 100 of FIG. 1 includes a store sampling rule generator 102 and a product sampling rule generator 104. The example store sampling rule generator 102 and/or the example product sampling rule generator 104 may receive a digital representation of and/or an identification of a geographic area of interest 106 to be analyzed. In some examples, a digital representation (e.g., an image) of the geographic area of interest 106 is processed and/or analyzed to define subregions (also referred to herein as subareas and/or patches) within the image of the geographic area of interest 106 that fit particular criteria and/or have particular characteristics.

The example system 100 of FIG. 1 further includes an aerial image repository 108 that provides image(s) of the specified geographic area of interest 106 to a requester (e.g., via a network 110 such as the Internet. The example images may include aerially-generated images (e.g., images captured from an aircraft) and/or satellite-generated images having any of multiple sizes and/or resolutions (e.g., images captured from various heights over the geographic areas). Example satellite and/or aerial image repositories that may be employed to implement the aerial image repository 108 are available from DigitalGlobe®, GeoEye®, RapidEye, Spot Image®, and/or the U.S. National Aerial Photography Program (NAPP). The example aerial image repository 108 of the illustrated example may additionally or alternatively include geographic data such as digital map representations, source(s) of population information, building and/or other man-made object information, and/or external source(s) for parks, road classification, bodies of water, etc.

The example store sampling rule generator 102, the example product sampling rule generator 104, and/or the example optimal foraging analyzer 114 of FIG. 1 access market channel information for areas similar to the geographic area of interest 106 from a market channel database 112 (e.g., via the network 110). The market channel database 112 stores market channel information derived from sampling, surveying, and/or other market knowledge. In some examples, the market channel information is stored in association with geographic information and/or characteristics that may be determined from an aerial image. Example market channel information that may be stored in the market channel database 112 includes associations of store locations, store brands, and/or store types with building information, product types found in stores, product brands found in stores, characteristics of geographic areas, store densities, descriptions of likely store locations, and/or associations of stores, store brands, store types, products, product brands, and/or product types to characteristics of a population. Additional types of market channel information are referenced below.

To analyze an aerial image of the geographic area of interest 106, the example system 100 of FIG. 1 includes an optimal foraging analyzer 114. The example optimal foraging analyzer 114 of FIG. 1 analyzes the aerial image of the geographic area of interest 106 to identify patches of stores, determine characteristics of the patches, and generate sampling rule(s) to be followed by persons sampling the geographic area of interest 106. The sampling rule(s) are to be used to locate the item of interest (referred to in optimal foraging theory as “prey”) and/or to vacate a patch to go to another patch when one or more conditions are present. As used herein, the term “prey” refers to an object of interest (e.g., for sampling). Example prey disclosed herein include stores, store brands, store types, products, product brands, and/or product types, among others.

The example optimal foraging analyzer 114 of FIG. 1 obtains aerial image(s) from the example aerial image repository 108 and market channel information from the market channel database 112 of FIG. 1. Based on the aerial image(s) and the market channel information, the optimal foraging analyzer 114 of the illustrated example analyzes the aerial image based on optimal foraging theory to determine a prey value (e.g., a weight), to determine characteristics of the geographic area of interest 106 and/or subregions thereof, to identify patches of stores, store brands, store types, products, product brands, and/or product types, and/or to estimate a density of prey in the geographic area of interest 106, in subregions, and/or in patches. The example optimal foraging analyzer 114 of FIG. 1 includes a geographic area analyzer 116, a patch identifier 118, a prey density estimator 120, and a prey value determiner 122.

To identify patches of stores, store brands, store types, products, product brands, and/or product types in the geographic area of interest 106, the geographic area analyzer 116 of the illustrated example analyzes the aerial image to locate buildings, groups of buildings, neighborhoods, roads, attractions, and/or any other features that may be identified from the aerial image. The example geographic area analyzer 116 may also analyze the aerial image to classify buildings based on market channel information such as the tendency of certain types of stores, store brands, store types, products, product brands, and/or product types to be found near certain types and/or patterns of buildings. A building may be classified based on size, location, densities of buildings in the area near the building, and/or other traits.

Based on the characteristics identified by the geographic area analyzer and/or based on market channel information from the market channel database 112, the example patch identifier 118 of FIG. 1 identifies one or more patches of prey in the geographic area of interest 106. In some examples, the patch identifier 118 determines subregions containing characteristics indicative of one or more types of prey. For example, subregions of the image containing large stores, such as supermarkets or club stores, may be identified as patches based on the presence of a large building and/or multiple large buildings in a nearby area. In some examples, parking lots may be identified near large buildings to identify large stores such as supermarkets.

After determining the patch locations, the example patch identifier 118 of FIG. 1 may determine a cost of moving between the patches and/or identify an optimal route to sample the patches to reduce interpatch travel costs. The interpatch travel costs may be based on, for example, a distance between a pair of patches, a cost of the person(s) performing the sampling (e.g., per hour wage costs, travel costs, etc.), difficulty in traveling between a pair of patches, and/or any other associated costs. The example patch identifier 118 may identify one or more lowest-cost routes to cover a set or subset of identified patches.

The example patch identifier 118 may identify a patch to include higher (or lower) concentrations of such large buildings, higher densities of any types of buildings, and/or other characteristics than in the aerial image (e.g., the geographic area of interest 106) as a whole. Small stores, such as convenience stores, may be identified based on the presence of buildings such as apartment buildings, clusters of small buildings, a lack of large buildings, or other traits. Similarly, the example patch identifier 118 may identify a patch to include higher (or lower) concentrations of such characteristics than in the aerial image (e.g., the geographic area of interest 106) as a whole. The example geographic area analyzer 116 and/or the patch identifier 118 may identify additional or alternative types of prey and/or patches based on appropriate characteristics.

To identify patches of products, the example patch identifier 118 of FIG. 1 determines characteristics of the aerial image and determines correlations with a product of interest based on market channel information. For example, if a product of interest is disproportionately purchased by persons with a higher socioeconomic status than with a lower socioeconomic status, the example patch identifier 118 identifies patches to include subregions of the geographic area of interest 106 that are associated with higher average socioeconomic status. Similarly, to identify patches of stores, the example patch identifier 118 determines correlations between stores of interest and characteristics of the aerial image based on the market channel information. For example, the appearance of a particular brand or type of store may indicate that a market channel has recently emerged and/or changed.

The example prey density estimator 120 of FIG. 1 estimates prey densities for product(s) and/or store(s) of interest based on the aerial image. An estimate of prey density may include an average amount of time that should be required to find and sample a unit of prey in a patch and/or in the geographic area of interest 106 based on the calculation of density and the size of the geographic area of interest 106.

In some examples, the prey density estimator 120 generates and/or updates estimated prey densities for products) and/or store(s) during sampling. For example, a mobile device 124 that is carried by a sampler may transmit sampling data to the prey density estimator 120 at regular and/or irregular intervals. The example prey density estimator 120 updates estimates of prey densities based on the observed sampling counts at the regular and/or irregular intervals.

The example prey value determiner 122 of FIG. 1 determines the value of particular stores, store brands, store types, products, product brands, and/or product types (e.g., prey value). For example, a supermarket may have a higher or lower prey value than a corner convenience store, depending on the market channel being sampled. A prey value refers to the value of a unit of an object of interest (e.g., a product, a product type, a product brand, a store, a store type, a store brand, etc.). Prey value may be expressed in terms of information and/or transformed to a monetary value (e.g., dollars) or some other unit of measuring value. A particular product brand of a type of product (e.g., Coca-Cola® soda for soft drinks) may have a higher prey value than others of the same type of product, depending on the research being conducted. In some examples, the prey value determiner 122 determines the prey value based on the market channel to be sampled and/or based on a party requesting the market channel information. A store may be valuable if, for example, the store indicates the growth of a market channel. A product may be valuable if, for example, the product indicates the presence of a demand of the product and/or other products (or services). In some examples, the prey value determiner 122 determines prey values based on the handling time(s) of the prey (e.g., the “ease” with which product(s) and/or store(s) are sampled). For example, a product type or store type that requires more time to sample may have a proportionally smaller value. In contrast, store(s), store type(s), store brand(s), product(s), product brand(s), and/or product type(s) that are considered to be more representative of a market (e.g., based on market channel information) may be more valuable than other store(s), store type(s), store brand(s), product(s), product brand(s), and/or product type(s) that are less representative of a market.

The example store sampling rule generator 102 and/or the example product sampling rule generator 104 receive optimal foraging information, such as identifications of patches, values of products and/or stores, estimated densities of products and/or stores, and/or characteristics of the patches, from the example optimal foraging analyzer 114. Based on the optimal foraging information, the example store sampling rule generator 102 and/or the example product sampling rule generator 104 may use optimal foraging theory and/or the market channel information from the market channel database 112 to generate sampling rules. For example, Charnov et al. (1976) describe the net energy intake rate for optimal foraging according to Equation 1 below:

$$En = \frac{\sum {P}_{i} \cdot {g}_{i} ( {T}_{i} ) - t \cdot {E}_{T}}{t + \sum {P}_{i} \cdot {T}_{i}} . \qquad ( Equation 1 )$$

In Equation 1, En refers to the net rate of energy intake, t is sum of inter-patch travel time and time spent in a patch, Pᵢ is the proportion of visited patches that are of type i (where i=1, 2, . . . , k), E_{T} is the energy cost per unit time in traveling between patches, gᵢ(Tᵢ) is the assimilated energy for Tᵢ time units corrected for the cost of searching in a patch of type i. The example store sampling rule generator 102 and/or the example product sampling rule generator 104 adapt the variables used in optimal foraging theory (e.g., in Equation 1) for use in sampling. For example, the net rate of energy intake En may refer to the number of the designated product or store identified by the sampler per unit time. The energy cost per unit time E_{T} may correspond to a monetary cost per unit of the sampler's time. The assimilated energy gᵢ(Tᵢ) corrected for searching costs may correspond to the number of a designated product or store identified by the sampler per unit of time spent both performing sampling (e.g., handling prey) and searching for products and/or stores of interest (e.g., searching for prey). The example store sampling rule generator 102 and/or the example product sampling rule generator 104 receive the optimal foraging information, sampling information, and/or market channel information to generate the appropriate rules.

Using Equation 1, the example store sampling rule generator 102 and/or the example product sampling rule generator 104 of the example of FIG. 1 may determine a leaving rule based on a lower (e.g., minimum) sampling rate and/or an upper amount of time that should be spent searching for a product or store. When a leaving rule condition is met, a person performing sampling is instructed to stop sampling the patch (e.g., proceed to the next patch and/or finish sampling). The leaving rule promotes sampling efficiency by cutting sampling short when the value of the additional information is less than the value of information that could be gained elsewhere in the same amount of time.

The example store sampling rule generator 102 of FIG. 1 generates store sampling rules including the location(s) and/or boundar(ies) of patches, value(s) of store type(s), value(s) of store brand(s) and/or leaving rule conditions. For example, based on the estimated store densities and the prey values, the store sampling rule generator 102 determines a leaving rule, which defines one or more conditions. When the leaving rule condition(s) are satisfied, the person (e.g., a human being) performing the sampling is to vacate the patch and travel to another patch. An example leaving rule may specify that if the person performing sampling does not encounter prey having at least a minimum value within a specified period of time, the person is to vacate the patch and travel to another patch.

The example product sampling rule generator 104 of FIG. 1 generates sampling rules for a person to sample product(s) (e.g., products for sale in stores), product type(s), and/or product brand(s). Like the example store sampling rule generator 102, the example product sampling rule generator 104 generates sampling rules including the location(s) and/or boundar(ies) of patches, prey value(s), and/or leaving rule conditions.

The example store sampling rule generator 102 and/or the product sampling rule generator 104 of FIG. 1 generate sampling rules based, in part, on sampled or measured market channel information (e.g., product brand(s) and/or product type(s), the demand for certain products, product brands, and/or product types, supply costs for products, product brands, and/or product types, a number of a designated product available for purchase in the geographic area or a number of different products of a designated type and/or brand that are available for purchase in the geographic area, etc.) for geographic areas similar to the geographic area of interest 106.

The example sampling plan(s) and/or sampling rule(s) generated by the sampling rule generators 102, 104 result, by design, in potential oversampling of the patches and/or the geographic area of interest 106. For example, because the sampler may be instructed to sample a given patch while the sampling rate is higher than an average estimated sampling rate of the geographic area of interest, the resulting sampling count is likely to be higher than would be accomplished using random sampling, transect sampling, or other non-informed sampling techniques (e.g., sampling performed without the aid of prior knowledge of the geographic area of interest 106 such as knowledge determined from the aerial image). Some example methods and apparatus disclosed herein generate a sampling plan that causes a sampler to search and sample for product(s) and/or store(s) of interest in a subregion (or patch) that has been estimated to have a higher-than-average concentration of the product(s) and/or store(s) of interest. Furthermore, example sampling plans instruct the sampler to stop sampling a patch when a particular rate of sampling and/or length of searching time reach a threshold (e.g., an average sampling rate).

The example system 100 of FIG. 1 further includes a sampling extrapolator 126 to correct for sampling counts based on the sampling plans by applying optimal foraging theory to extrapolate the sampling counts to estimate a total number of product(s) and/or store(s) of interest that is representative of the geographic area of interest 106. For example, the sampling extrapolator 126 may determine a function representative of the sampling counts to estimate the total number of product(s) and/or store(s) of interest for a patch. The example sampling extrapolator 126 may control the function to have an upper limit (e.g., similar in shape to a logarithmic function). In some examples, the function and/or the upper limit are determined using previously-sampled areas (e.g., a determinable relationship between sampling results and totals).

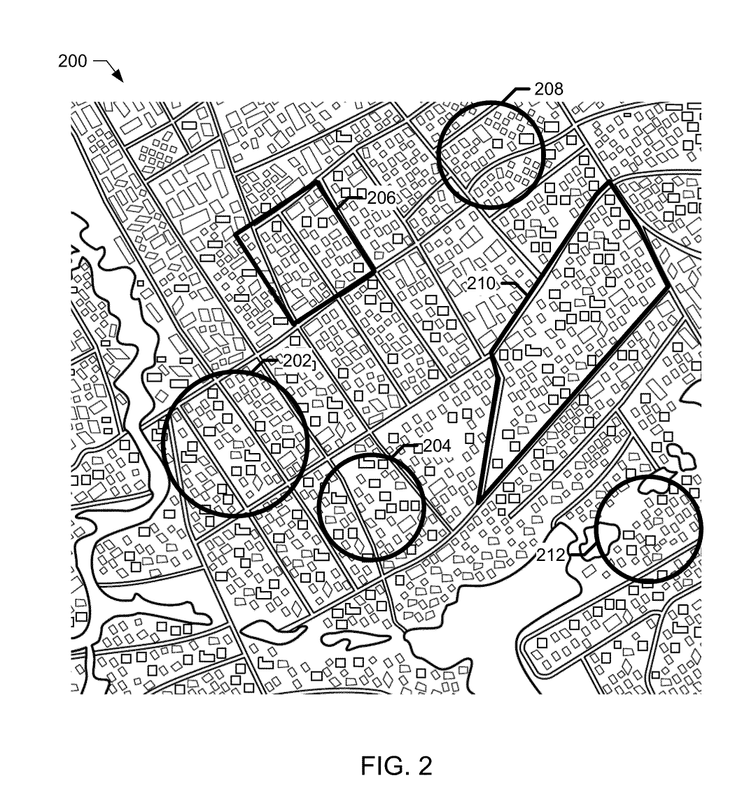

FIG. 2 illustrates an example aerial image 200 that may be used to sample products and/or stores in a geographic area, including example patches 202-212 of stores and/or products. The example aerial image 200 may be requested by and/or provided to the example optimal foraging analyzer 114 of FIG. 1 by the aerial image repository 108 of FIG. 1.

The example geographic image analyzer 116 of FIG. 1 analyzes the image 200 to determine characteristics of the image 200. For example, the geographic image analyzer 116 determines sizes of buildings in the image 200, densities of buildings in the image 200, and/or patterns of buildings in the image 200, among other things. Using the characteristics determined by the geographic image analyzer 116, the example patch identifier 118 of FIG. 1 identifies the patches 202-212 based on store(s) and/or products) of interest. In some examples, the patch identifier 118 determines different ones of the patches 202-212 to be of different types (e.g., including different products and/or stores of interest). For example, patch identifier 118 may estimate the patches 206, 208 to be of a first type associated with a first product of interest and estimate the patches 210, 212 to be of a second type associated with a second product of interest. The example patch identifier 118 may additionally or alternatively estimate the patches 202, 204 to be of a mixed type and/or primarily of one type.

The example prey density estimator 120 of FIG. 1 estimates estimated prey densities for the products) and/or store(s) of interest in the patches 202-212. The prey densities are based on market channel information received from the market channel database 112 of FIG. 1. For example, the market channel information may indicate that an average of X units of a particular brand of soft drink per unit area are found in areas having similar characteristics as the patch 202. The example prey density estimator 120 may determine an expected sampling rate for the patch 202, an average expected sampling rate for the geographic area of interest 106, and/or a threshold time to search for store(s), store type(s), store brand(s), product(s), product brand(s), and/or product type(s) of interest (e.g., based on the estimated density of the patch 202 and/or the geographic area of interest 106).

The example prey value determiner 122 of FIG. 1 determines the value(s) of the respective product(s) and/or store(s) to be sampled in the patches 202-212. For example, prey may have different values in different ones of the patches 202-212 based on the types of the patches. For example, a particular store, a store brand, and/or type of store may have a first value in a first patch 202 and have a second value in a second patch 204 due to the presence of more and/or less valuable stores in the second patch 204 that are not present in the first patch.

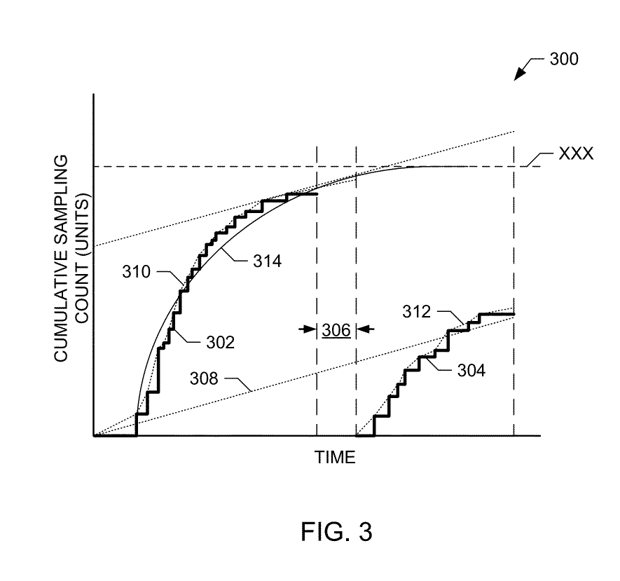

FIG. 3 is a chart 300 illustrating an example sampling procedure based on identified patches (e.g., the patches 202-212 of FIG. 2) and generated sampling rules. The example chart 300 illustrates a relationship between intake (e.g., cumulative sampling counts of a product, product brand, product type, store, store brand, or store type of interest) and time for two different patches. A first trace 302 illustrates the intake by a sampler in a first patch (e.g., one of the patches 202-212 of FIG. 2) and a second trace 304 illustrates the intake by the sampler in a second patch (e.g., a different one of the patches 202-212 of FIG. 2). The example traces 302, 304 are separated in time by an interpatch travel time 306. The example chart 300 further includes an average estimated sampling rate 308 (e.g., time to locate X units of the product of interest) in the geographic area of interest 106.

The first example trace 302 of FIG. 3 shows a sampler's count of a product of interest, during which time the human sampler repeatedly searches (e.g., horizontal portions of trace 302) and, upon finding the product of interest, counts the product of interest (e.g., positively sloping or vertical portions of the trace 302, based on handling time of the product of interest). After a period of time of sampling, the rate at which the human sampler finds the product of interest decreases (as illustrated by a dotted line 310 showing the approximate slope of the trace 302), until the searching rate 310 for the patch is less than the average estimated sampling rate 308 and/or until the sampler does not find the product of interest for an amount of time corresponding to the average estimated sampling rate 308. In the example of FIG. 3, a leaving rule (e.g., a rule generated by the product sampling rule generator 104 of FIG. 1) specifies that the sampler is to stop sampling the patch when the searching rate 310 falls below the average estimated sampling rate 308 and/or when the sampler does not find the product of interest for at least a time period. Based on the leaving rule, the sampler stops sampling the patch.

The second example trace 302 of FIG. 3 shows the sampler's count of the same or another product and/or store of interest for a different patch than the trace 302. The example trace 304 illustrates a rate at which the sampler finds the product of interest in the second patch, represented by a dotted line 312. As with the first patch, the example sampler searches and samples the second patch until a leaving condition is met. The example leaving condition is the same for both patches because the same average estimated sampling rate 308 applies to all of the patches in the example geographic area of interest 106. When the sampling rate 312 of the second trace 304 becomes less than the example average estimated sampling rate 308 and/or the sampler does not find the product of interest in at least the time period, the sampler is to stop sampling the second patch. The sampler may move to a third patch and/or finish sampling the geographic area of interest 106.

The example sampling extrapolator 126 of FIG. 1 extrapolates the sampling counts determined from the traces 302, 304 to total numbers of prey that exist in the patches. For example, the sampling extrapolator 126 determines a function 314 representative of the example trace 302. Instead of being linear as in typical sampling extrapolation, the example function 314 resembles a logarithmic function to reflect the fact that sampling the “easiest” products and/or stores generally result in a higher rate of sampling than the estimated average sampling rate. The example function 314 has an upper cumulative sampling count limit 16 (e.g., the total number of prey in the patch sampled to generate the trace 302). The example sampling extrapolator 126 of FIG. 1 determines the function and the resulting upper cumulative sampling count 316 to estimate the total prey in the patch. The estimated total prey may then be used as a measurement of market channel(s) in the patch and/or, in combination with the measurements of other patches, a measurement of the geographic area of interest 106.

While an example manner of implementing the system 100 is illustrated in FIG. 1, one or more of the elements, processes and/or devices illustrated in FIG. 1 may be combined, divided, re-arranged, omitted, eliminated and/or implemented in any other way. Further, the example store sampling rule generator 102, the example product sampling rule generator 104, the example aerial image repository 108, the example market channel database 112, the example optimal foraging analyzer 114, the example geographic area analyzer 116, the example patch identifier 118, the example prey density estimator 120, the example prey value determiner 122, the example mobile device 124, the example sampling extrapolator 126 and/or, more generally, the example system 100 of FIG. 1 may be implemented by hardware, software, firmware and/or any combination of hardware, software and/or firmware. Thus, for example, any of the example store sampling rule generator 102, the example product sampling rule generator 104, the example aerial image repository 108, the example market channel database 112, the example optimal foraging analyzer 114, the example geographic area analyzer 116, the example patch identifier 118, the example prey density estimator 120, the example prey value determiner 122, the example mobile device 124, the example sampling extrapolator 126 and/or, more generally, the example system 100 could be implemented by one or more circuit(s), programmable processor(s), application specific integrated circuit(s) (ASIC(s)), programmable logic device(s) (PLD(s)) and/or field programmable logic device(s) (FPLD(s)), etc. When reading any of the apparatus or system claims of this patent to cover a purely software and/or firmware implementation, at least one of the example store sampling rule generator 102, the example product sampling rule generator 104, the example aerial image repository 108, the example market channel database 112, the example optimal foraging analyzer 114, the example geographic area analyzer 116, the example patch identifier 118, the example prey density estimator 120, the example prey value determiner 122, the example mobile device 124, and/or the example sampling extrapolator 126 are hereby expressly defined to include a tangible computer readable storage device or storage disc such as a memory, DVD, CD, Blu-ray, etc. storing the software and/or firmware. Further still, the example system 100 of FIG. 1 may include one or more elements, processes and/or devices in addition to, or instead of, those illustrated in FIG. 1, and/or may include more than one of any or all of the illustrated elements, processes and devices.

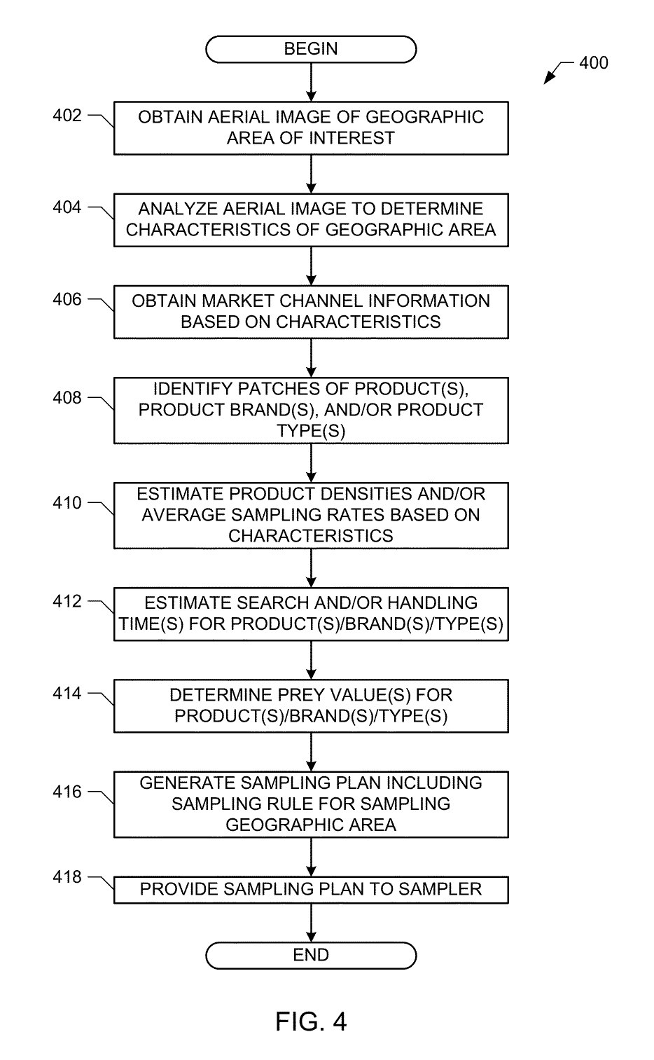

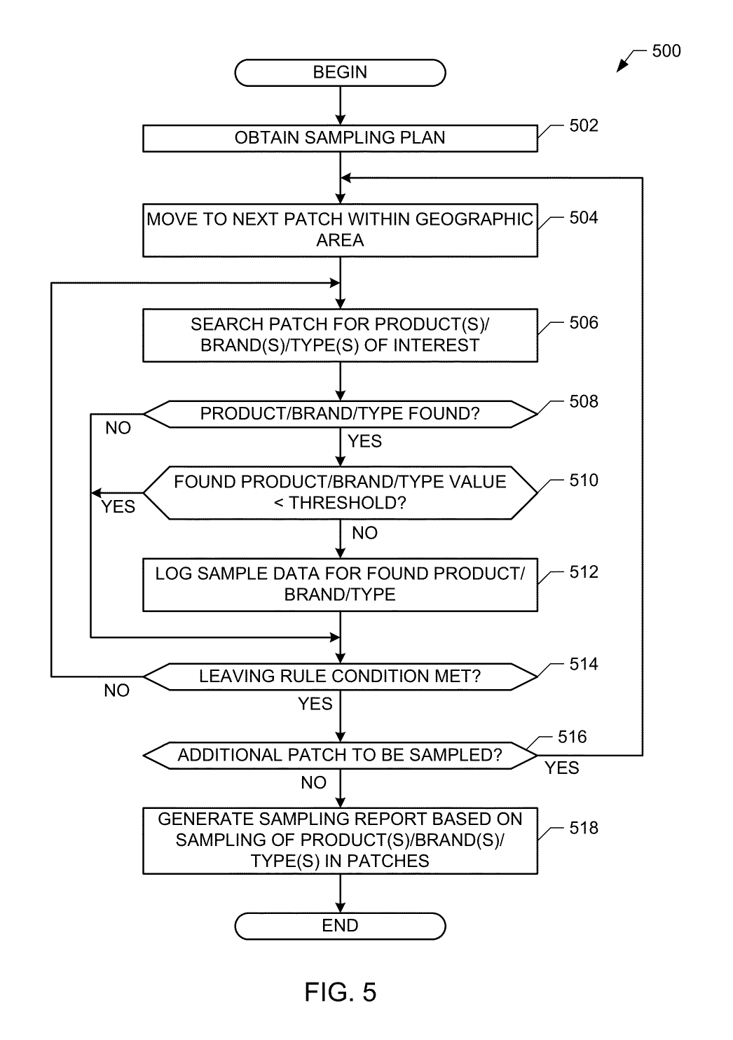

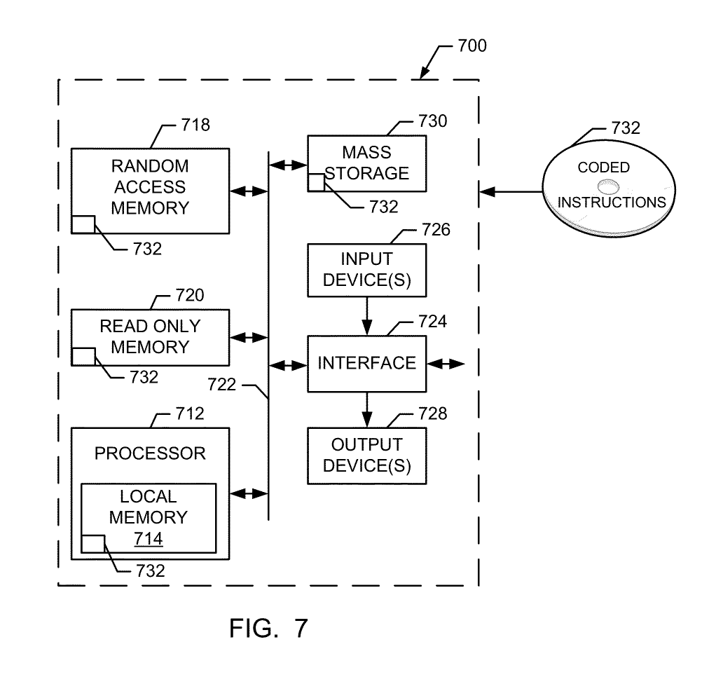

Flowcharts representative of example machine readable instructions for implementing the system 100 of FIG. 1 are shown in FIGS. 4, 5, and/or 6. In this example, the machine readable instructions comprise programs for execution by a processor such as the processor 712 shown in the example processor platform 700 discussed below in connection with FIG. 7. The programs may be embodied in software stored on a tangible computer readable storage medium such as a CD-ROM, a floppy disk, a hard drive, a digital versatile disk (DVD), a Blu-ray disk, or a memory associated with the processor 712, but the entire programs and/or parts thereof could alternatively be executed by a device other than the processor 712 and/or embodied in firmware or dedicated hardware. Further, although the example programs are described with reference to the flowcharts illustrated in FIGS. 4-6, many other methods of implementing the example system 100 may alternatively be used. For example, the order of execution of the blocks may be changed, and/or some of the blocks described may be changed, eliminated, or combined.

As mentioned above, the example processes of FIGS. 4-6 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIGS. 4-6 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disc and to exclude propagating signals. As used herein, when the phrase “at least” is used as the transition term in a preamble of a claim, it is open-ended in the same manner as the term “comprising” is open ended.

FIG. 4 is a flowchart representative of example computer readable instructions 400 which may be executed to generate a sampling plan to sample products in a geographic area based on aerial images. The example instructions may be executed to implement, for example, the product sampling rule generator 104, the aerial image repository 108, the market channel database 112, the optimal foraging analyzer 114, the geographic area analyzer 116, the patch identifier 118, the prey density estimator 120, and/or the prey value determiner 122 of FIG. 1. The example instructions 400 of FIG. 4 may be modified to generate a sampling plan to sample stores, store brands, and/or store types in the geographic area.

The example optimal foraging analyzer 114 of FIG. 1 obtains an aerial image of a geographic area of interest (e.g., the geographic area of interest 106 of FIG. 1) (block 402). The example aerial image may be obtained from the aerial image repository 108 of FIG. 1. The geographic area analyzer 116 of FIG. 1 analyzes the aerial image to determine characteristics of the geographic area (block 404).

The example optimal foraging analyzer 114 further obtains market channel information based on the characteristics of the geographic area (block 406). For example, the patch identifier 118, the prey density estimator 120, and/or the prey value determiner 122 may obtain market channel information (e.g., from the market channel database) such as previously-determined relationships between product(s), product type(s), product brand(s), store(s), store brand(s), and/or store type(s) and characteristics such as those determined by the geographic area analyzer 116. The market channel information may have been previously determined by measurements, sampling, surveying, and/or any other technique to develop market intelligence.

The example patch identifier 118 of FIG. 1 identifies patches of product(s), product brand(s), and/or product type(s) based on the characteristics and/or the market channel information (block 408). For example, the patch identifier 118 may identify subregions containing characteristics indicative of one or more types of prey. For example, subregions of the image containing large stores, such as supermarkets or club stores, may be identified as patches based on the presence of a large building and/or multiple large buildings in a nearby area. In some examples, parking lots may be identified near large buildings to identify large stores such as supermarkets. The example patch identifier 118 outputs the identifications of patches, such as via geographical coordinates (e.g., latitude and longitudes of vertices) and/or landmark descriptions (e.g., descriptions of boundaries of the patches such as streets and/or buildings).

The example prey density estimator 120 of FIG. 1 estimates a product densities and/or average sampling rates for patches and/or for the geographic area of interest 106 based on the characteristics (block 410). For example, the prey density estimator 120 may estimate the densities of a product or product type available in stores based on the likelihood of certain types and/or brands of stores being present, socioeconomic status(es), transportation facilities, and/or any other characteristics determined for subregions of the geographic area of interest. The example prey density estimator 120 may estimate the densities for each of multiple subregions and/or each of multiple product(s), product brand(s) and/or product type(s).

The example prey value determiner 122 of FIG. 1 determines handling time(s) for product type(s) and/or product brand(s) of interest (block 412). The handling time of a product may be based on, for example, the time required to search for a product such as entering a store, locating the product within the store, counting a number of the product in the store, and exiting the store. Additional and/or alternative handling costs may also be present. Furthermore, the handling costs may be converted to a monetary value and/or other units.

The example prey value determiner 122 of FIG. 1 determines prey values for each product, product brand, and/or product type of interest (block 414). The prey values determine whether particular products and/or product types are passed over for sampling in favor of more beneficial or valuable products, product brands, or product types. For example, the number of a particular brand of soft drink in a patch or in the geographic area of interest 106 may provide more information regarding a market channel than the presence of other brand(s) of soft drink.

The example product sampling rule generator 104 of FIG. 1 generates a sampling plan including sampling rule(s) for sampling the geographic area of interest 106 (block 416). For example, the sampling plan may include a set of rules representative of instructions to a person performing sampling of the geographic area of interest 106. Example sampling rules may include the identification(s) of product(s), product brand(s), and/or product type(s) to be sampled, identifications of patch boundaries, a sequence of patches to be sampled, leaving rule(s), and/or prey values and/or threshold values. The example sampling plan may be provided to a sampler (e.g., a person or team of persons to perform sampling).

In some examples, determining the prey values (block 414) may take into account the respective search and/or handling times of the products, product brands, and/or product types. In some other examples, the prey values are independent of the search and/or handling times, and both the prey values and the costs are used to generate the sampling rules and/or sampling plans (block 416).

The example product sampling rule generator 104 provides the sampling plan to a sampler (e.g., a person or team of persons to perform the sampling according to the sampling plan and/or rules) (block 418). The example instructions 400 may then end and/or iterate to generate a sampling plan for another geographic area.

While FIG. 4 is described with reference to determining a sampling plan and/or sampling rules for sampling products, product brands, and product types, the example instructions may be applied to determining a sampling plan and/or sampling rules for sampling stores, store brands, and store types. To this end, the example blocks 408-416 may be adapted to use different characteristics determined by the example geographic area analyzer from the aerial image and/or to obtain different market channel information to identify patches of stores (block 408), estimate store densities and/or average sampling rates (block 410), estimate search and/or handling times for stores, store brands, and/or store types (block 412), determine prey values for stores, store brands, and/or store types (block 414), and generate a sampling plan including sampling rules for sampling stores, store brands, and/or store types in the geographic area (block 416).

FIG. 5 is a flowchart representative of an example method 500 to perform sampling of products in a geographic area. The example method 500 may be performed according to a sampling plan and/or sampling rules generated by the product sampling rule generator 104 of FIG. 1. However, the example method 500 may be modified to perform sampling of, for example, stores, store brands, and/or store types in a geographic area according to a sampling plan and/or sampling rules generated by the store sampling rule generator 102 of FIG. 1.

The example method 500 of FIG. 5 begins by obtaining (e.g., from the product sampling rule generator 104 of FIG. 1) a sampling plan (block 502). The example sampling plan obtained in block 502 includes one or more sampling rules, such as the identification(s) of product(s), product brand(s), and/or product type(s) to be sampled, identifications of patch boundaries, a sequence of patches to be sampled, leaving rule(s), and/or prey values and/or threshold values. In the example of FIG. 5, the sampling plan is generated based on an aerial image of a geographic area of interest 106.

The example method 500 includes moving to a next (e.g., first) patch (e.g., the patch 202 of FIG. 2) within a geographic area of interest (e.g., the geographic area of interest 106 of FIG. 1) (block 504). The patch 202 may be defined by a set of landmarks, a set of coordinates, and/or any other system of navigation mutually understood between the plan generator and the sampler. Once in the patch 202, the example method 500 includes searching the patch 202 for product(s), product brand(s), and/or product type(s) of interest (block 506). The product(s), product brand(s), and/or product type(s) of interest may be defined by the sampling plan.

If a product, product brand, or product type is found (block 508), the example method 500 determines whether a prey value of the found product, product brand, or product type is at least a threshold (block 510). If the product, product brand, or product type is at least a threshold (block 510), the example method 500 includes logging the sample data (e.g., a number of the product found, a number of the brand of product found, a number of the product type found, a store, a store brand, and/or a store type in which the product, product brand, or product type is found, a time at which the product type or product brand is found, etc.) (block 512). The product, product brand, or product type value threshold may be provided in the sampling plan and/or may be determined for the current patch based on the product(s) and/or product type(s) of interest that are present in the patch 202.

After logging the sample data (block 512), if a product, product brand, or product type is not found (block 508), or if a found product, product brand, or product type value is less than a threshold (block 512), the example method 500 determines whether a leaving rule condition has been met (block 514). For example, a sampler may determine whether a threshold amount of time has passed without finding and/or counting a product, product brand, or product type of interest. If a leaving rule condition has not been met (block 512), the method 500 returns to block 506 to continue searching the patch 202.

When a leaving rule condition is met (block 514), the method 500 determines whether there are additional patches to be sampled (block 516). For example, the sampling plan may specify a patch to be sampled following the present patch. If there are additional patches to be sampled (block 514), the method 500 returns to block 504 to move to the next patch within the geographic area. When there are no additional patches to be sampled (block 516), the method 500 generates a sampling report based on sampling the product(s), product brand(s), and/or product type(s) of interest in the patches (block 518). The sampling report may be used to inform marketing and supply decisions for current and/or emerging markets. The example method 500 may then end and/or iterate for a different sampling plan and/or a different geographic area.

While FIG. 5 is described with reference to determining a sampling plan and/or sampling rules for sampling products, product brands, and product types, the example instructions may be applied to sampling stores, store brands, and store types. To this end, the example blocks 502, 506-512, and 518 may be adapted to obtain a store sampling plan (block 502), search a patch for store(s), store brand(s), and/or store type(s) (block 506), determine whether a store, store brand, or store type is found (block 508), determine whether a value of a found store, store brand, or store type is at least a threshold value (block 510), log sample data for a found store, store brand, or store type (block 512), and generate a sampling report based on sampling the stores, store brands, and/or store types based on the store sampling plan (block 518).

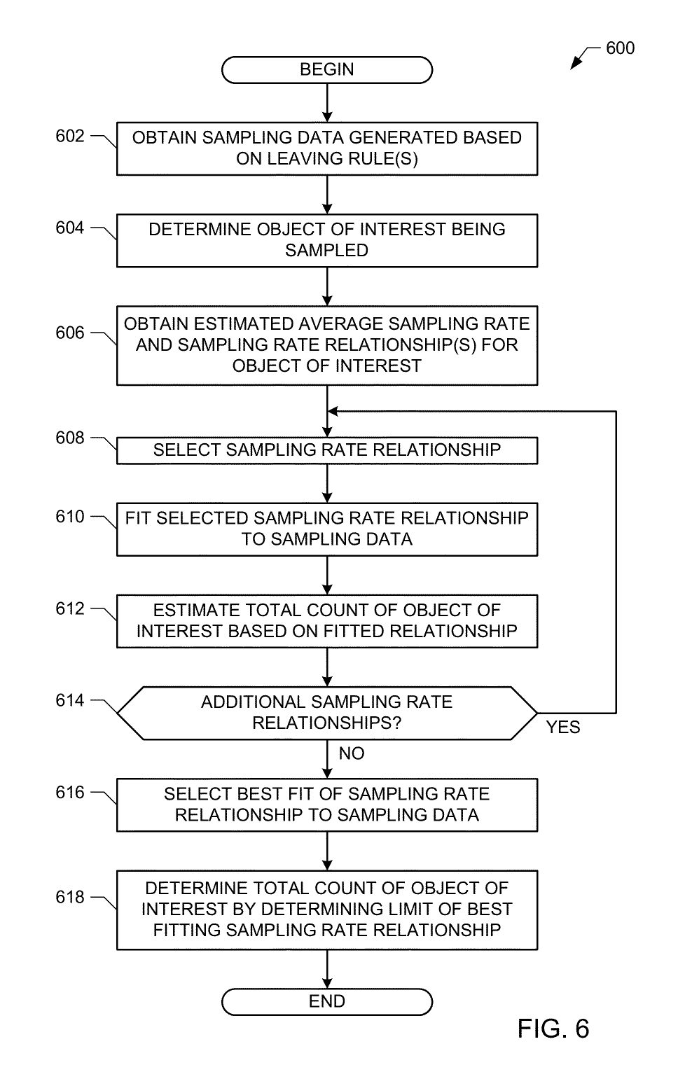

FIG. 6 is a flowchart representative of example computer readable instructions 600 which may be executed to determine a total count of an object of interest from sampling data collected based on sampling rules. In the example of FIG. 6, the sampling rules from which the sampling data are collected are determined based on optimal foraging techniques and aerial image analysis. The example instructions 600 of FIG. 6 may be executed to implement the sampling extrapolator 126, the market channel database 112, and/or the mobile device 124 of FIG. 1.

The example sampling extrapolator 126 of FIG. 1 obtains sampling data generated based on leaving rule(s) (block 602). The leaving rule(s) may be generated by the example sampling rule generators 102, 104 of FIG. 1 and used by a sampler having the mobile device 124. The example sampler may input sampling data into the mobile device 124 for transmission to the sampling extrapolator 126 and/or provide the sampling data for manual input to the sampling extrapolator 126. The example sampling extrapolator 126 determines the object of interest being sampled (block 604). The object of interest being sampled, such as a product, a product type, a product brand, a store, a store brand, or a store type, may be provided by the sampler and/or via a sampling rule.

The example sampling extrapolator 126 obtains an estimated average sampling rate and one or more sampling rate relationship(s) for the object of interest (block 606). Sampling rate relationship(s) define relationships between sampling results and total numbers of an object of interest. Sampling rate relationships may be determined theoretically (e.g., based on optimal foraging theory and/or sampling theory) and/or empirically (e.g., by determining patterns of past sampling results). Different products may have different relationships between sampling data (e.g., samples collected until a leaving rule condition is met, such as a sampling rate being equal to an estimated average sampling rate) and total numbers of the object of interest. Furthermore, sampling rate relationships may be different between sampling a product and sampling a store. The example sampling extrapolator 126 may obtain the sampling rate relationship(s) from the market channel database 112 of FIG. 1.

The example sampling extrapolator 126 selects a first sampling rate relationship (block 608). The sampling extrapolator 126 fits the selected sampling rate relationship to the sampling data (block 610). For example, the sampling extrapolator 126 may adjust variables in the selected relationship to reduce a least squares fit (or other modeling method) with the sampling data. The resulting function results may result in a limit corresponding to an estimated total count of the object of interest. The example sampling extrapolator 126 estimates the total count of the object of interest based on the fitted relationship (block 612).

The example sampling extrapolator 126 determines whether there are additional sampling rate relationships (e.g., to fit to the sampling data) (block 614). For example, the object of interest may fit into multiple possible categories of relationships, each relationship potentially resulting in a different estimate of the total count. If there are additional sampling rate relationships (block 614), control returns to block 608 to selected another relationship. When there are no more relationships (block 614), the example sampling extrapolator 126 selects a best fit of the sampling rate relationship to the sampling data (block 616). For example, the sampling extrapolator 126 may determine which of the relationships has the best correlation with the sampling data and/or which of the relationships results in reaching the estimated average sampling rate at the closest time to the time reached in the sampling data. The example sampling extrapolator 126 estimates a total count of the object of interest by determining the limit of the best fitting sampling rate relationship (block 618). The total count may be used, for example, to inform marketing and/or supply chain decisions for emerging and/or developing markets. The example instructions 600 of FIG. 6 may then end.

FIG. 7 is a block diagram of an example processor platform 700 capable of executing the instructions of FIGS. 4, 5, and/or 6 to implement the system 100 of FIG. 1. The processor platform 700 can be, for example, a server, a personal computer, a mobile device (e.g., a cell phone, a smart phone, a tablet such as an iPad™), a personal digital assistant (PDA), or any other type of computing device.

The processor platform 700 of the illustrated example includes a processor 712. The processor 712 of the illustrated example is hardware. For example, the processor 712 can be implemented by one or more integrated circuits, logic circuits, microprocessors or controllers from any desired family or manufacturer.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), and/or a PCI express interface.

In the illustrated example, one or more input devices 722 are connected to the interface circuit 720. The input device(s) 722 permit a user to enter data and commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 720 of the illustrated example, thus, typically includes a graphics driver card.

The interface circuit 720 of the illustrated example also includes a communication device such as a transmitter, a receiver, a transceiver, a modem and/or network interface card to facilitate exchange of data with external machines (e.g., computing devices of any kind) via a network 726 (e.g., an Ethernet connection, a digital subscriber line (DSL), a telephone line, coaxial cable, a cellular telephone system, etc.).

The processor platform 700 of the illustrated example also includes one or more mass storage devices 728 for storing software and/or data. Examples of such mass storage devices 728 include floppy disk drives, hard drive disks, compact disk drives, Blu-ray disk drives, RAID systems, and digital versatile disk (DVD) drives.

The coded instructions 732 of FIGS. 4-6 may be stored in the mass storage device 728, in the volatile memory 714, in the non-volatile memory 716, and/or on a removable tangible computer readable storage medium such as a CD or DVD.

From the foregoing, it will be appreciated that methods, apparatus, and articles of manufacture have been described which improve the efficiency and effectiveness of sampling market channels. Example methods, apparatus, and articles of manufacture disclosed herein use optimal foraging techniques and analysis of aerial images to develop sampling rules and determine areas to be sampled to obtain market channel information. In contrast to known techniques of sampling and surveying, example methods, apparatus, and articles of manufacture disclosed herein reduce costs associated with human sampling and enable improved access to sampling in locations where human sampling was previously impracticable by lowering the costs and/or risks of obtaining market channel information in such locations.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method, comprising:
identifying, using a processor, a first geographic area to be sampled for a first product, the identifying being based on an aerial image;
estimating, using the processor, a density of the first product in the first geographic area; and
calculating, using the processor, a sampling rule to be used in sampling the first geographic area for the first product.

2. A method as defined in claim 1, further comprising sampling the first geographic area based on the sampling rule to estimate a market channel corresponding to the first product.

3. A method as defined in claim 1, further comprising estimating a density of a second product in the first geographic area, wherein calculating the sampling rule is based on the estimated density of the first product and the estimated density of the second product.

4. A method as defined in claim 3, wherein calculating the sampling rule comprises determining an amount of time to be spent searching for the first product based on the estimated density of the first product and the estimated density of the second product.

5. A method as defined in claim 3, further comprising assigning a first prey value to the first product and assigning a second prey value to the second product.

6. A method as defined in claim 5, wherein calculating the sampling rule comprises determining an amount of time to be spent searching for the first product based on a comparison of the first prey value and the second prey value.

7. A method as defined in claim 5, wherein assigning the first prey value to the first product is based on an extent to which a presence of the first product is representative of a market channel associated with the first product or a third product.

8. A method as defined in claim 1, wherein calculating the sampling rule comprises determining a sequence of geographic areas to be sampled including the first geographic area based on costs of traveling between the geographic areas.

9. A method as defined in claim 1, wherein the sampling rule comprises an instruction to stop sampling the first geographic area when the first product has not been encountered in at least a threshold time.

10. A method as defined in claim 1, further comprising calculating a cost of sampling the first product, the sampling rule being based on the cost of sampling the first product.

11. A method as defined in claim 1, further comprising estimating a total number of the first product for sale in the first geographic area based on sampling results generated in accordance with the sampling rule.

12. A method as defined in claim 1, wherein calculating the sampling rule is based on the following equation:
$$En = \frac{\sum {P}_{i} \cdot {g}_{i} ( {T}_{i} ) - t \cdot {E}_{T}}{t + \sum {P}_{i} \cdot {T}_{i}} ,$$
wherein En is a number of the first product identified by a sampler per unit time, t is a sum of time spent in the first geographic area and travel time between the first geographic area and a second geographic area, Pᵢ is the proportion of visited patches that are associated with the first product, E_{T} is a cost per unit of time spent sampling by the sampler, and gᵢ(Tᵢ) is a number of the first product identified by the sampler per unit of time spent performing sampling and searching for the first product for Tᵢ time units.

13. A method as defined in claim 1, wherein identifying the first geographic area comprises:
analyzing the aerial image of the first geographic area to determine a first characteristic;
comparing the first characteristic of the first geographic area to a second characteristic of a second geographic area; and
identifying the first geographic area when the first and second characteristics match.

14. An apparatus, comprising:
a patch identifier to select a first geographic area to be sampled for a first product, the selection being based on an aerial image;
a prey density estimator to estimate a density of the first product in the first geographic area; and
a sampling rule generator to generate a sampling rule to be used in sampling the first geographic area for the first product.

15. An apparatus as defined in claim 14, further comprising a geographic area analyzer to:
analyze the aerial image of the first geographic area to determine a first characteristic;
compare the first characteristic of the first geographic area to a second characteristic of a second geographic area; and
identify the first geographic area when the first and second characteristics match.

16. An apparatus as defined in claim 14, further comprising a prey value determiner to determine a prey value of the first product, the sampling rule generator to generate the sampling rule based on the prey value.

17. An apparatus as defined in claim 16, wherein the prey value determiner is to assign a first prey value to the first product and assign a second prey value to a second product, the sampling rule generator to generate the sampling rule based on a comparison of the first prey value and the second prey value.

18. An apparatus as defined in claim 14, further comprising a sampling extrapolator to estimate a total number of the first product for sale in the first geographic area based on sampling results generated in accordance with the sampling rule.

19. An apparatus as defined in claim 14, wherein the sampling rule comprises an instruction to stop sampling the first geographic area when the first product has not been encountered in at least a threshold time.

20. A tangible computer readable storage medium comprising computer readable instructions which, when executed by a processor, cause the processor to at least:
identify a first geographic area to be sampled for a first product, the identifying being based on an aerial image;
estimate a density of the first product in the first geographic area; and
calculate a sampling rule to be used in sampling the first geographic area for the first product.

21. A storage medium as defined in claim 20, wherein the instructions are further to cause the processor to estimate a density of a second product in the first geographic area, wherein calculating the sampling rule is based on the estimated density of the first product and the estimated density of the second product.

22. A storage medium as defined in claim 21, wherein the instructions are to cause the processor to calculate the sampling rule by determining an amount of time to be spent searching for the first product based on the estimated density of the first product and the estimated density of the second product.

23. A storage medium as defined in claim 21, wherein the instructions are further to cause the processor to assign a first prey value to the first product and assign a second prey value to the second product.

24. A storage medium as defined in claim 23, wherein the instructions are to cause the processor to calculate the sampling rule by determining an amount of time to be spent searching for the first product based on a comparison of the first prey value and the second prey value.

25. A storage medium as defined in claim 23, wherein the instructions are to cause the processor to assign the first prey value to the first product based on an extent to which a presence of the first product is representative of a market channel associated with the first product or a third product.

26. A storage medium as defined in claim 20, wherein the instructions are to cause the processor to calculate the sampling rule by determining a sequence of geographic areas to be sampled including the first geographic area based on costs of traveling between the geographic areas.

27. A storage medium as defined in claim 20, wherein the sampling rule comprises an instruction to stop sampling the first geographic area when the first product has not been encountered in at least a threshold time.

28. A storage medium as defined in claim 20, wherein the instructions are further to cause the processor to calculate a cost of sampling the first product, the sampling rule being based on the cost of sampling the first product.

29. A storage medium as defined in claim 20, wherein the instructions are further to cause the processor to estimate a total number of the first product for sale in the first geographic area based on sampling results generated in accordance with the sampling rule.
